(19) United States
(12) Patent Application Publication
(10) Pub. No.: US 2011/0035509 A1
(43) Pub. Date: Feb. 10, 2011

(54) System and Method for High Speed transfer of Files over a Network

(76) Inventor: Steven Carter Powell, St. Paul, MN (US)

Correspondence Address: BRENDAN BABCOCK, 1814 Rock Springs Road, Columbia, TN, 38401, US

(21) Appl. No.: 12/835,740

(22) Filed: Jul. 14, 2010

Related U.S. Application Data
(60) Provisional application No. 61/273,522, filed on Aug. 6, 2009.
(60) Provisional application No. 61/273,523, filed on Aug. 6, 2009.
(60) Provisional application No. 61/274,465, filed on Aug. 18, 2009.

(51) Int. Cl. G06F 15/16

(52) U.S. Cl. 709/236

(57) ABSTRACT

The present invention is related to computer data handling, more particularly rapid transmission of large files across a network. It is more particularly related to downloading large files across a peer-to-peer network. By breaking up a large file into smaller data packets and storing in random but known locations, both the storage process and the retrieval process may be greatly speeded up, because the data packets are processed in parallel through different communications ports. Hash codes are used to eliminate redundant file storage and different servers can be used to store and transmit different data packets. A unique file identifier is associated with each data packet allowing for the individual data packets to be catalogued and also tracked at any location within the network.

### CROSS-REFERENCES TO RELATED APPLICATIONS

This application claims the benefit of U.S. Provisional Patent Application Ser. Nos. 61/270,728 “Ultrafast Method of Transmitting Data Packets of any Size over a Digital Transport”, filed Jul. 13, 2009; 61/273,522 “Unique File Identification System”, filed Aug. 6, 2009; 61/273,523 “Digital File Library of Unique File IDs”, filed Aug. 6, 2009, and 61/274,465 “Unique Method of Distribution of Information in Digital Form over a Trusted Peer Network with Specific Structure, filed Aug. 20, 2009, the contents of which are herein incorporated by reference in their entirety.

### FIELD OF THE INVENTION

The present invention is related to computer data handling, more particularly rapid transmission of large files across a network. It is more particularly related to downloading large files across a peer-to-peer network. By breaking up a large file into smaller data packets and storing in random but known locations, both the storage process and the retrieval process may be greatly speeded up, because the data packets are processed in parallel through different communications ports. Hash codes are used to eliminate redundant file storage and different servers can be used to store and transmit different data packets. A unique file identifier is associated with each data packet allowing for the individual data packets to be catalogued and also tracked at any location within the network.

### BACKGROUND OF THE INVENTION

Most home computer networks today are peer to peer (“P2P”) networks. Residential users configure their computers in peer workgroups to allow sharing of files, printers and other resources equally among all of the devices. Although one computer may act as a file server or Fax server at any given time, other home computers often have equivalent capability to handle those responsibilities. Both wired and wireless home networks qualify as peer to peer environments.

Webopedia defines peer-to-peer as “a type of network in which each workstation has equivalent capabilities and responsibilities. This differs from client/server architectures, in which some computers are dedicated to serving the others.” This definition captures the traditional meaning of peer to peer networking. Computers in a peer to peer network are typically situated physically near to each other and run similar networking protocols and software.

In most P2P networks, the “peers” are computer systems which are connected to each other via the Internet. Files can be shared directly between systems on the network without the need of a central server. In other words, each computer on a P2P network becomes a file server as well as a client.

The only requirements for a computer to join a peer-to-peer network are an Internet connection and P2P software. Common P2P software programs include Kazaa, Limewire, BearShare, Morpheus, and Acquisition. These programs connect to a P2P network, such as “Gnutella,” which allows the computer to access thousands of other systems on the network.

Once connected to the network, P2P software allows a user to search for files on other user's computers, typically only within a single folder that users have designated to share. While P2P networking makes file sharing easy and convenient, the size of files and the available bandwidth along with the data traffic on the network often results in long download times when sending files between users.

There is an ongoing need for systems, programs, and methods that improve the speed of transfer of large files between users in a network.

### SUMMARY OF THE INVENTION

The present invention is related to computer data handling, more particularly rapid transmission of large files across a network. It is more particularly related to downloading large files across a peer-to-peer network. By breaking up a large file into smaller data packets and storing in random but known locations, both the storage process and the retrieval process may be greatly speeded up, because the data packets are processed in parallel through different communications ports. Hash codes are used to eliminate redundant file storage and different servers can be used to store and transmit different data packets. A unique file identifier is associated with each data packet allowing for the individual data packets to be catalogued, and also tracked at any location within the network.

Additional features and advantages are realized through the techniques of the present invention. Other embodiments and aspects of the invention are described in detail herein and are considered a part of the claimed invention. For a better understanding of the invention with advantages and features, refer to the description and to the drawings.

### BRIEF DESCRIPTION OF THE DRAWINGS

The subject matter which is regarded as the invention is particularly pointed out and distinctly claimed in the claims at the conclusion of the specification. The foregoing and other objects, features, and advantages of the invention are apparent from the following detailed description taken in conjunction with the accompanying drawings in which:

FIG. 1 is a diagram for storing data packet pieces of a file across one or more servers in a network.

FIG. 2 is a diagram for retrieving and assembling a large file.

FIG. 3 is a diagram for creating the unique file identifier and matching it to the file library.

The detailed description explains the preferred embodiments of the invention, together with advantages and features, by way of example with reference to the drawings.

### DESCRIPTION OF THE PREFERRED EMBODIMENTS

The present invention provides an optimized download service within a network computing environment, particularly in a peer-to-peer environment.

In a network, this invention uses the model of Requestor and a Sender. The Requestor is the user that requests a specific file and the Sender is the user that sends the file across the network to the Requestor. In a preferred embodiment, the Requestor and the Sender are part of a peer-to-peer network.

1) File Storage and Retrieval

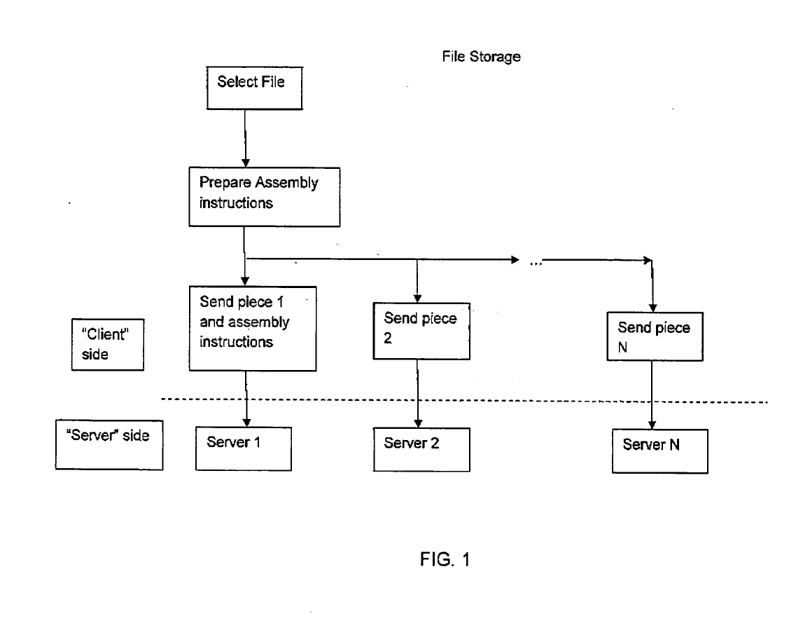

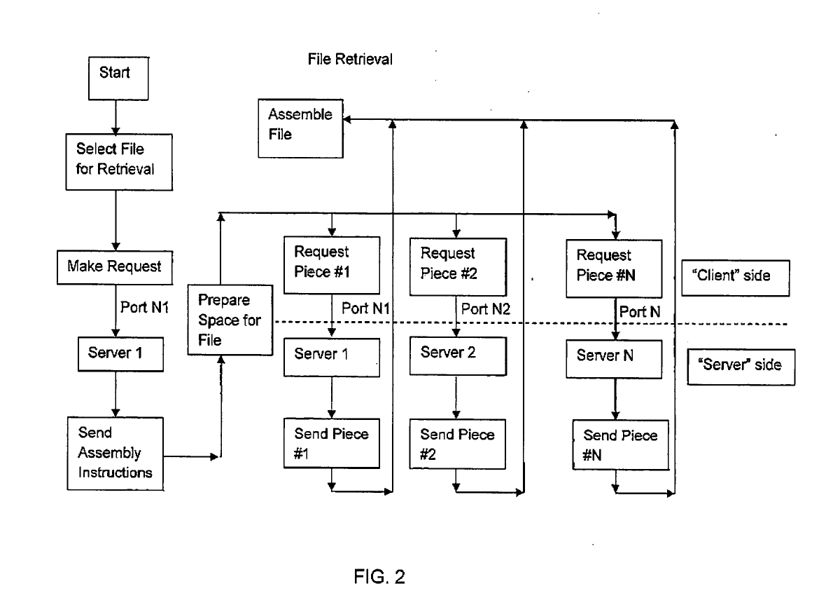

Diagrams for the file storage and retrieval are shown in FIG. 1 and FIG. 2. The diagrams are for optimized processes and do not include any error testing or error processing steps.

A file can be selected for sending by many means including selecting an icon, picking from a list (or decision tree), picking from a command line, etc. Assembly instructions are prepared by breaking the file down into separate data packets. The data packets can all be the same size, in which case the total number of data packets is equal to the total file length (bytes) divided by the length (bytes) of each data packet. The data packets can also be of unequal sizes.

The individual data packets are sent out in parallel over the network over all available servers along with the assembly instructions. Assembly instructions comprise the piece number for the packet, the hash code for that packet, the IP address, and the byte location in the total file. For example, data packet piece 1 is sent over port N1 to server 1 at IP address N1. Pieces 2 through PN are sent over ports P2 through PN and with IP addresses N1 through NN.

A file can be selected for retrieval by many means including selecting an icon, picking from a list (or decision tree), picking from a command line, etc. After the server has received the file request and verified that the file information is present, assembly instructions are sent to the requestor. Assembly instructions include the designation of data packet pieces 1 through N, located on servers 1 through N at their assigned IP addresses, and the starting byte location for each piece. Memory space for the incoming file is identified on the requestor node. The requestor requests Pieces 1 through PN to be sent over ports P2 through PN and with IP addresses N1 through NN.

As the data packet pieces of the file are received, they are stacked in the proper order in the memory space previously provided.

2) Unique File Identifier

A unique file identifier can be compiled by applying a consistent algorithm, process, calculation, or methodology by which every byte in a digital packet (or file) is taken into account to generate a unique number.
A) For the identifier, each byte is considered. A byte is recognized to be a sequence of eight bits, each bit which is either a one (1) or a zero (0).
B) The generated number by itself is not necessarily unique, as there is an infinite number of file possibilities and in all forms. Considering the infinite number of possible number combinations, applying a methodology to mathematically guarantee uniqueness works against process which is seeking to maximize speed.
C) Therefore, to make a unique identifier that can be used with both the sender and the requestor and also allow for fast transfer of files, well-known identifiers of the file or packet are combined with the generated number. Any number of the common characteristics of the file or packet could be used, including, but not limited to, the following:
   a. The length of the file or packet itself
   b. Value of a specific and consistent sequence (range) of bits within the file or packet.
D) Other characteristics commonly associated with the file or packet that could change over time would not be used in the determination of the unique file identifier. Such characteristics include name, type, creation date, etc.
This unique file identifier would apply to any file from any origination. Further, the identifier would be the same regardless of the operating system or digital storage medium used.

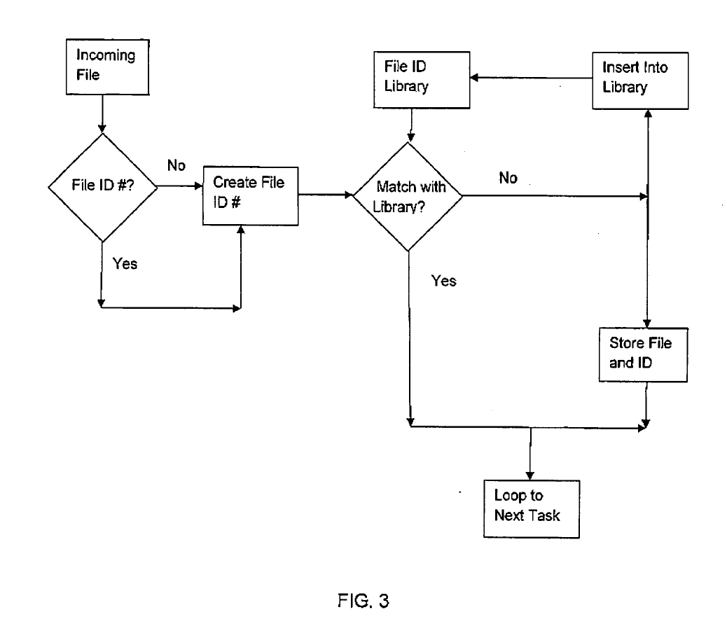

3) Digital File Library
A diagram for the digital file library is shown in FIG. 3.
A) Using the unique file identifier, it is possible to catalog every file once it has been created and made known. The digital collection of files or packets can be centralized within a single database. Each file or packet's location can be identified in a specific location on a given server and any given server can be located throughout the world.
B) Only one copy of any file or packet needs to be maintained within the server framework in order for it to exist and be made available for use by any individual or entity (the requestor) that requires its access as long as said access is allowed to that requestor.
C) A list of allowable requestors can be maintained and associated with a specific file or packet.
D) A file or packet can be associated as part of a group and can be identified as part of the group in a number of ways including, but not limited to, outdated, required, optional, for-a-fee, etc. Further each group may itself be identified as a specific collection with any number of files or packets that consist of that collection as identified by each file's unique identifier.

4) Digital Distribution
A) Using an access list and a methodology of access permissions, each file or packet or each collection or group of files or packet may be digitally distributed in whole or in part upon request
B) Files or packets may be digitally distributed to a specific location as determined by the requestor within distributed to a specific location as determined by the requestor within rules specified by the owner of the collection.
C) A collection of files or packets may be distributed in whole or in part as determined by the owner of the collection.
D) A collection may include one or may files or packets.
E) Collection owners may charge for access to their collection.

5) Trusted Peer Network (TPN)
A) A trusted peer network consists of a group of computers or nodes which are linked together and are uniquely identified and well-known by the network as a whole, by an individual server, or a series of servers.
B) Each computer or node associated with the TPN has a given set of permissions granting access to the TPN.
C) The network is capable of quickly and securely transmitting files or packets between individual nodes or computers located on the network.
D) Each node or computer may maintain one or more parts of one or more files that is part of the digital file library.
E) The file or packet on the node may or may not be the only copy of the file within the network.
F) Each file or packet has its own unique identifier which is identifiable in an encrypted or unencrypted format.
G) Because of the methodology used to create the unique file identifier, any virus which may attach itself to the file or packet will be eliminated as a counterfeit by the TPN Transmission Protocol. Any “spoof” of the file or packet will be identified as a fraud because the unique file identifier will not match the original.
H) Files or packets are well-known based on their identifier, determined by the contents of the file, regardless of filename, type, or location within any system.
I) Files or packets that are transmitted within the TPN are assured of being in the exact format of the file or packet when it is first created and made known to the network by its file identifier.

In an embodiment, the invention may be practiced using a representative workstation or server hardware system. The system comprises a representative computer system, such as a personal computer, a workstation or a server, including optional peripheral devices. The workstation includes one or more processors and a bus employed to connect and enable communication between the processor(s) and the other components of the system in accordance with known techniques. The bus connects the processor to memory and long-term storage devices which can include a hard drive, diskette drive or tape drive for example. The system might also include a user interface adapter, which connects the microprocessor via the bus to one or more interface devices, such as a keyboard, mouse, a Printer/scanner, and/or other interface devices, which can be any user interface device, such as a touch sensitive screen, digitized entry pad, etc. The bus also connects a display device, such as an LCD screen or monitor, to the microprocessor via a display adapter.

The system may communicate with other computers or networks of computers by way of a network adapter capable of communicating with a network. Example network adapters are communications channels, token ring, Ethernet or modems. Alternatively, the workstation may communicate using a wireless interface, such as a CDPD (cellular digital packet data) card. The workstation may be associated with such other computers in a Local Area Network (LAN) or a Wide Area Network (WAN), or the workstation can be a client in a client/server arrangement with another computer, etc. Preferably, the workstation and any other devices are associated with a peer-to-peer network. All of these configurations, as well as the appropriate communications hardware and software, are known in the art.

In an embodiment, the present invention is implemented as one or more computer software programs. The implementation of the software of the present invention may operate on a user's workstation, as one or more modules or applications which are invoked upon request. Alternatively, the software may operate on a server in a network, or in any device capable of executing the program code implementing the present invention. The logic implementing this invention may be integrated within the code of an application program, or it may be implemented as one or more separate utility modules which are invoked by that application, without deviating from the inventive concepts disclosed herein. The application may be executing in a Web environment, where a Web server provides services as a Sender in response to requests from an Originator connected through the Internet. In another embodiment, the application may be executing in a corporate intranet or extranet, or in any other network environment. Various environments and configurations are well known in the art.

Systems, components, methods, and programs for improving transmission speed of large files can also be found in the following US patents and US patent applications, all of which are incorporated by reference in their entirety:
U.S. Pat. No. 7,209,973
US Application 2007/0050590
US Application 2004/0088380
US Application 2008/0256175
U.S. Pat. No. 7,417,967

The systems described herein are just examples. There may be many variations without departing from the spirit of the invention. For instance, the steps may be performed in a differing order, or steps may be added, deleted or modified. All of these variations are considered a part of the claimed invention.

While different embodiments of the invention have been illustrated and described herein, it is to be understood that the invention is not limited to the precise construction herein disclosed, and the right is reserved to all changes and modifications coming within the scope of the invention as defined in the appended claims.

What is claimed is:

1. A computer implemented method in a peer-to-peer computing infrastructure for optimized file download between an requestor and a sender using parallel downloads of a plurality of data packets of desired download data from a plurality of servers, the method comprising the steps of:
a. Requestor making a request for a file
b. Sender dividing file into a plurality of individual data packets
c. Assigning a unique file identifier to each data packet
d. Transmitting the data packets in parallel across a plurality of servers
e. Monitoring available bandwidth and transmission speed of data packets across the plurality of servers
f. Assembling the data packets at requestor using the unique file identifiers to assemble the transmitted file into its original state.

2. The method of claim 1 wherein the originator is a handheld device.

3. The method of claim 1 wherein the sender is a handheld device.

4. The method of claim 2 wherein the handheld device is a mobile phone.

5. The method of claim 2 wherein the handheld device is a scanner.

6. The method of claim 1 wherein the unique file identifier comprises a characteristic of the data packet.

7. The method of claim 5 wherein the characteristic is the value of a specific and consistent sequence of bits.

8. A computer program product for optimized file download between an requestor and a sender using parallel downloads of a plurality of data packets of desired download data from a plurality of servers, the computer program product comprising a storage medium readable by a processing circuit and storing instructions for performing a method comprising the steps of:
a. Requestor making a request for a file
b. Sender dividing file into a plurality of individual data packets
c. Assigning a unique file identifier to each data packet
d. Transmitting the data packets in parallel across a plurality of servers
e. Monitoring available bandwidth and transmission speed of data packets across the plurality of servers
f. Assembling the data packets at requestor using the unique file identifiers to assemble the transmitted file into its original state.

9. The computer program product of claim 8 wherein the originator is a handheld device.

10. The computer program product of claim 8 wherein the sender is a handheld device.

11. The computer program product of claim 9 wherein the handheld device is a mobile phone.

12. The computer program product of claim 9 wherein the handheld device is a scanner.

13. The computer program product of claim 8 wherein the unique file identifier comprises a characteristic of the data packet.

14. The computer program product of claim 13 wherein the characteristic is the value of a specific and consistent sequence of bits.

15. A system in a peer-to-peer computing infrastructure for optimized file download between a requestor and a sender using parallel downloads of a plurality of data packets of desired download data from a plurality of servers, the computer system comprising a processor in communication with a network, wherein the processor is capable of performing a method comprising:
a. Requestor making a request for a file
b. Sender dividing file into a plurality of individual data packets
c. Assigning a unique file identifier to each data packet
d. Transmitting the data packets in parallel across a plurality of servers
e. Monitoring available bandwidth and transmission speed of data packets across the plurality of servers
f. Assembling the data packets at requestor using the unique file identifiers to assemble the transmitted file into its original state.

16. The system of claim 15 wherein the requestor is a handheld device.

17. The system of claim 15 wherein the sender is a handheld device.

18. The system of claim 17 wherein the handheld device is a mobile phone.

19. The system of claim 17 wherein the handheld device is a scanner.

20. The system of claim 15 wherein the unique file identifier comprises a characteristic of the data packet.
